(19) United States
(12) Patent Application Publication
(10) Pub. No.: US 2013/0290145 A1
(43) Pub. Date: Oct. 31, 2013

(54) METHOD AND SYSTEM FOR MOBILE COMPARISON SHOPPING

(71) Applicant: NeoMedia Technologies, Inc., Boulder, CO (US)

(72) Inventor: Robert T. Durst, JR., Dunstable, MA (US)

(21) Appl. No.: 13/848,458

(22) Filed: Mar. 21, 2013

Related U.S. Application Data
(60) Provisional application No. 61/616,136, filed on Mar. 27, 2012.

(51) Int. Cl. G06Q 30/06

(52) U.S. Cl. CPC G06Q 30/0629
USPC 705/26.64

(57) ABSTRACT

A comparison shopping method comprising reading with a portable device a product code comprising a product identifier that identifies a product of interest located at a local store; transmitting the product identifier to a comparison shopping server computer; the comparison shopping server computer obtaining price information from a plurality of shopping server computers; the comparison shopping server computer determining the identity of the local store; the comparison shopping server requesting a local store server associated with the local store to provide a real-time offer for purchase of the product from the local store; the local store server computer calculating the real-time offer; the local store server computer sending the real-time offer to the comparison shopping server computer; and the comparison shopping server computer sending the price information from the plurality of shopping server computers and the real-time offer to the portable device.

### TECHNICAL FIELD

This invention relates to mobile comparison shopping, and in particular to a mobile comparison shopping system that provides for a local store where the product of interest is located to provide a real-time offer to compete with online vendors.

### BACKGROUND OF THE INVENTION

There are a number of current mobile phone applications that allow a user to scan a product code such as a UPC or EAN on product packaging in a physical bricks and mortar store and then initiate a search with a database to determine pricing and availability of the same items from other vendors. For example, using an application such as Shop Savvy, a user uses their camera equipped mobile phone to scan the UPC code on a product and then return a display of various vendors of that product and respective pricing. These vendors often include both online (e.g. Amazon) and other bricks and mortar stores.

Although this may be useful for the consumer, it can be a problem for the retailer since, if the item is purchased from an alternative vendor, they may end up bearing the cost of serving as a showroom of merchandise without being able to generate revenue from the sale of the product being scanned. This can lead to certain retail outlets trying to either ban consumer scanning for comparison price shopping or blocking communication to comparative shopping web services. In either case, it can result in a hostile environment for consumers wishing to shop using a mobile comparison shopping service. In the case of comparison shopping, a consumer is looking for the best price and best convenience of purchasing an item, while the bricks and mortar merchant displaying the item is trying to capture the sale of an interested buyer at the best margin possible.

A consumer who had identified a lower price for an item may approach a sales clerk in the bricks and mortar store and bargain with them for a price adjustment. This interaction proves daunting for certain consumers who may be more likely to either leave and buy from a competing merchant or forego the purchase altogether. Even if they are motivated to negotiate, they may not be able to find a clerk or the store may have policies that preclude bargaining or matching the price of an online retailer. Finally, simply matching the lowest price may preclude a merchant realizing higher margin for sale of a product if the consumer is willing to pay a slightly higher price for the convenience of immediate possession of the product and avoidance of shipping charges.

### SUMMARY OF THE INVENTION

Provided is a comparison shopping method comprising the steps of reading with a portable device a product code comprising a product identifier that identifies a product of interest located at a local store; transmitting the product identifier to a comparison shopping server computer; the comparison shopping server computer obtaining price information from a plurality of shopping server computers; the comparison shopping server computer determining the identity of the local store; the comparison shopping server requesting a local store server associated with the local store to provide a real-time offer for purchase of the product from the local store; the local store server computer calculating a real-time offer for purchase of the product from the local store; the local store server computer sending the real-time offer for purchase of the product from the local store to the comparison shopping server computer; and the comparison shopping server computer sending the price information from the plurality of shopping server computers and the real-time offer for purchase of the product from the local store to the portable device.

Also provided is a comparison shopping system comprising (a) a portable device programmed to: read with a portable device a product code comprising a product identifier that identifies a product of interest located at a local store, and transmit the product identifier to a comparison shopping server computer; (b) a comparison shopping server computer programmed to: obtain price information from a plurality of shopping server computers, determine the identity of the local store, and requesting a local store server associated with the local store to provide a real-time offer for purchase of the product from the local store; and (c) a local store server computer programmed to: calculate a real-time offer for purchase of the product from the local store, and send the real-time offer for purchase of the product from the local store to the comparison shopping server computer; and wherein the comparison shopping server computer is further programmed to send the price information from the plurality of shopping server computers and the real-time offer for purchase of the product from the local store to the portable device.

### BRIEF DESCRIPTION OF THE DRAWING

FIG. 1 illustrates the system of the preferred embodiment of the present invention.

FIG. 2 is a flowchart of the preferred embodiment of the present invention.

### DETAILED DESCRIPTION OF THE PREFERRED EMBODIMENTS

The present invention is a system and method where the bricks and mortar merchant may participate in comparative shopping in order to try to sell the product immediately while the consumer is in the store with an intent to buy.

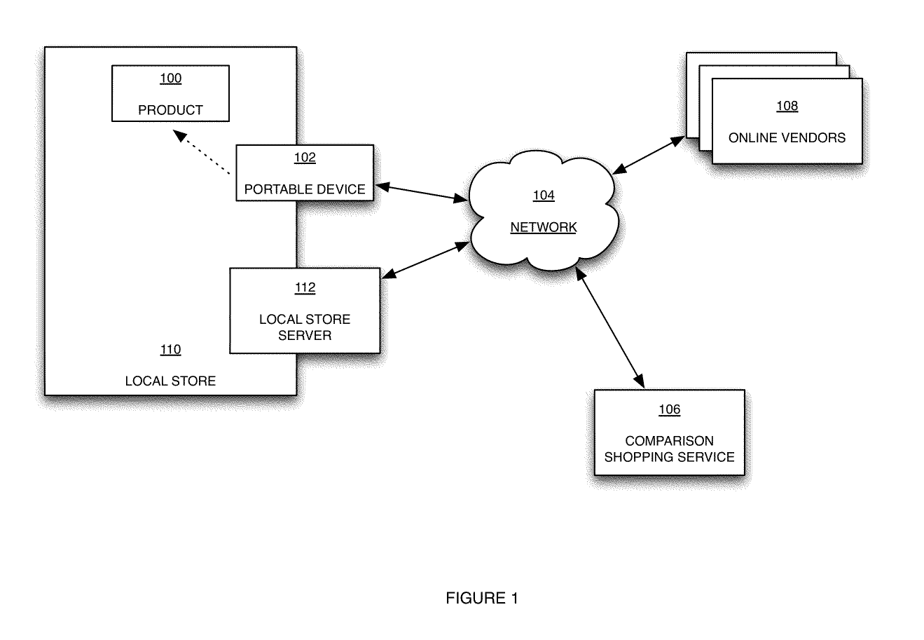

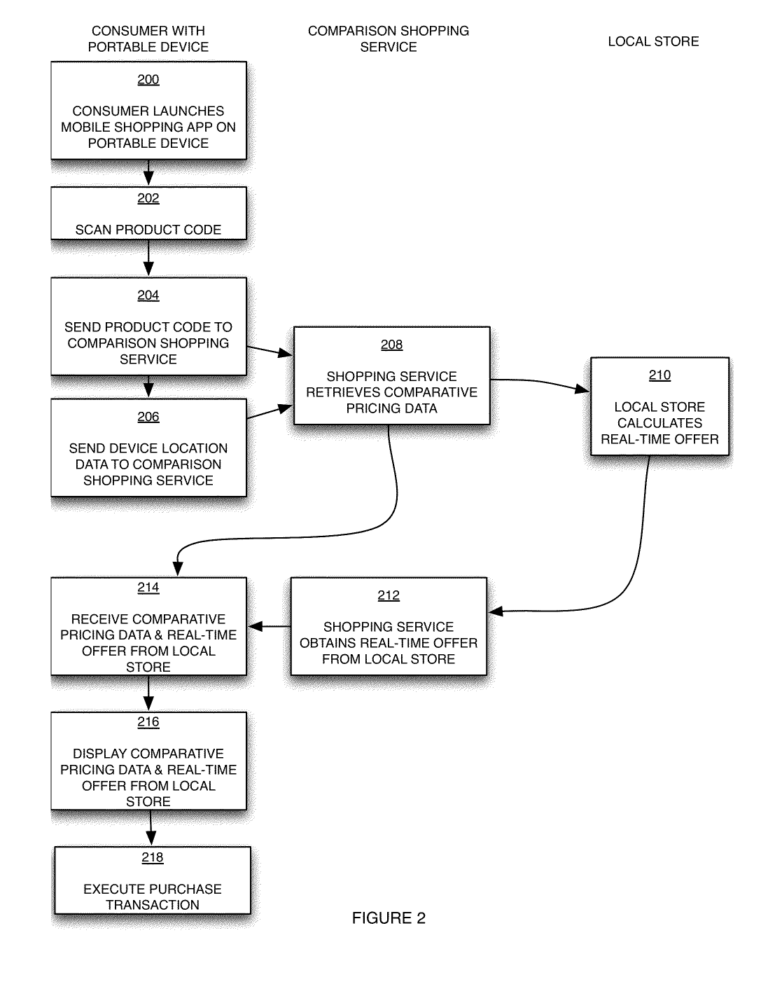

FIG. 1 illustrates the system of the preferred embodiment of the present invention. A local store 110 will have various products 100 on display for sale, each with some type of identifying code such as a UPC. A consumer using a portable device such as an IPHONE can find a product of interest and, with reference to FIG. 2, the consumer at step 200 launches a comparative shopping mobile application on the portable device 102 that is capable of reading a machine-readable data carrier that identifies the product item. This could be an existing product barcode (e.g. UPC or EAN), a 2D code printed on the product or the product packaging (e.g. a QR code), or another form of machine-readable data carrier such as an RFID tag (e.g. an NFC product tag). At step 202 the portable device is used to scan or otherwise read the product code.

At step 204, the application on the portable device sends the product code and/or identification information to a comparison shopping web service 106 via the network 104 (such as the Internet), which at step 208 gathers competitive pricing and availability data for the product item from a variety of vendors 108 so that the consumer can make a decision regarding purchase.

At step 206, the application also reads and sends to the comparison shopping service the identification or location of the bricks and mortar store 110 where the consumer and the portable device 102 are located. This could be in the form of store identifier broadcast as an SID in that store and then compared to a database on the comparative shopping service. This may also be the geographical location of the consumer and the portable device based on a form of location based services (LBS) such as GPS or augmented with a database using Assisted GPS (e.g., Skyhook).

The service identifies the location of the store 110 where the consumer is present using one of these methods and provides a means for this physical store to participate in the comparison evaluation since the consumer will have expressed purchase interest and intent. This is accomplished by communicating with the local store server 112. At step 210 the local store server 112 receives the web pricing information from the service 106 and calculates a real-time offer to compete with the web pricing. The real-time offer calculated by the store may be based upon one or more premises using conditional logic as follows.

The comparison pricing service may simply provide the consumer with standard store pricing assuming that the convenience of immediate purchase will offset lower pricing and shipping costs. If the bricks and mortar merchant is registered they may have subscribed to conditional logic that evaluates and matches the lowest competitive price in order to capture the sale. Some illustrative examples would include the following.

The merchant may also have specified logic to determine their pricing based upon the relationship of one or more factors including: (i) product margins based upon inventory costs; (ii) a calculation based upon the number and distribution of the competitive pricing offers from other vendors; (iii) pricing based upon loaded shipping costs and delayed gratification factors (time estimated for delivery); (iv) the convenience of buying at another bricks and mortar based upon distance, store hours, etc.; (v) merchant defined parameters to capture the immediate sale with motivation of pricing, package offers (get this price if you buy this and that), etc.

This logic could either be predetermined or set up in the context of an auction with other competing vendors (e.g. a reverse auction where the price bid of different vendors is incremented up to a threshold with notification to those vendors or their agents when their thresholds have been reached so that they can decide if they wish to modify them).

The merchant may also extend their offer for a limited period of time and/or only to that individual with the presentation of ID at POS (a limited, expiring offer).

At step 212 the comparison shopping service obtains the real-time offer calculated by the local store and passes this real-time offer back to the portable device along with the comparative pricing data from web-vendors at step 214. At step 216 the web comparison pricing and the local real-time offer are displayed to the consumer on the portable device, and at step 218 the consumer may execute the desired transaction based on the information that is displayed.

A limited (or unlimited) offer could be provided to the consumer on their device in the form of a machine-readable token (e.g. a 2D mobile coupon code) redeemable at point of sale.

Meta data is collected regarding (i) the scan of the product code for comparative shopping purposes; (ii) comparative offers including differential pricing; (iii) whether the offer is acted upon or not; and (iv) timing and latency of associated redemption and purchase.

In one embodiment the process described could be providing using just a web service and without a client on the consumer device where display of comparison pricing information and all communications is conducted using standard web forms. In this case the bricks and mortar merchant would subscribe to the web service and implement appropriate onsite information regarding identification of their location as well as rules regarding pricing, offers, etc.

In another embodiment the consumer could use a dedicated application on their mobile device that would make them eligible to receive comparison offers from bricks and mortar vendors, perhaps in exchange for opt in registration of user information or other consideration.

What is claimed is:

1. A comparison shopping method comprising the steps of:
reading with a portable device a product code comprising a product identifier that identifies a product of interest located at a local store;
transmitting the product identifier to a comparison shopping server computer;
the comparison shopping server computer obtaining price information from a plurality of shopping server computers;
the comparison shopping server computer determining the identity of the local store;
the comparison shopping server requesting a local store server associated with the local store to provide a real-time offer for purchase of the product from the local store;
the local store server computer calculating a real-time offer for purchase of the product from the local store;
the local store server computer sending the real-time offer for purchase of the product from the local store to the comparison shopping server computer; and
the comparison shopping server computer sending the price information from the plurality of shopping server computers and the real-time offer for purchase of the product from the local store to the portable device.

2. A comparison shopping system comprising:
(a) a portable device programmed to:
read with a portable device a product code comprising a product identifier that identifies a product of interest located at a local store, and
transmit the product identifier to a comparison shopping server computer;
(b) a comparison shopping server computer programmed to:
obtain price information from a plurality of shopping server computers,
determine the identity of the local store, and
requesting a local store server associated with the local store to provide a real-time offer for purchase of the product from the local store; and
(c) a local store server computer programmed to:
calculate a real-time offer for purchase of the product from the local store, and
send the real-time offer for purchase of the product from the local store to the comparison shopping server computer; and
wherein the comparison shopping server computer is further programmed to send the price information from the plurality of shopping server computers and the real-time offer for purchase of the product from the local store to the portable device.
